(19) United States
(12) Patent Application Publication
(10) Pub. No.: US 2010/0290746 A1
(43) Pub. Date: Nov. 18, 2010

(54) DROP CABLE PASS-THRU FITTING

(75) Inventors: Oscar Fernando Bran de León, Belle Plaine, MN (US); James J. Solheid, Lakeville, MN (US)

Correspondence Address: MERCHANT & GOULD PC, P.O. BOX 2903, MINNEAPOLIS, MN, 55402-0903, US

(73) Assignee: ADC Telecommunications, Inc., Eden Prairie, MN (US)

(21) Appl. No.: 12/754,796

(22) Filed: Apr. 6, 2010

Related U.S. Application Data
(60) Provisional application No. 61/167,106, filed on Apr. 6, 2009.

(51) Int. Cl. G02B 6/44

(52) U.S. Cl. 385/100

(57) ABSTRACT

A cable pass-thru assembly includes a fiber optic cable and a pass-thru fitting. The fiber optic cable includes an optical fiber and a strength member. The pass-thru fitting is adapted to receive the fiber optic cable. The pass-thru fitting includes an outer sleeve and an inner sleeve. The outer sleeve includes a thru-bore. The inner sleeve is disposed in the thru-bore of the outer sleeve. The strength member is compressed between the inner sleeve and the outer sleeve. A method for inserting a fiber optic cable in a pass-thru fitting includes inserting a fiber optic cable through a thru-bore of an outer sleeve and a bore of an inner sleeve. A strength member of the fiber optic cable is wrapped about the inner sleeve. The outer sleeve is advanced over the inner sleeve so that the strength member is compressed between the outer sleeve and the inner sleeve.

### CROSS-REFERENCE TO RELATED APPLICATIONS

This application claims priority to U.S. Patent Application Ser. No. 61/167,106 entitled “Drop Cable Pass-Thru Fitting” and filed on Apr. 6, 2009, the disclosure of which is hereby incorporated by reference in its entirety.

BACKGROUND

Fiber optic enclosures can be used in fiber optic networks to provide an access location for subscribers to a main fiber optic cable. These fiber optic enclosures typically include connection ports at which fiber optic connectors of a subscriber cable can be engaged to established fiber optic connectivity for a given subscriber location.

In some instances, however, the subscriber cable does not include fiber optic connectors. In some instances, the subscriber cable is spliced to the fiber optic cables within the fiber optic enclosure. Therefore, it is desirable to have a fitting that can mount to the fiber optic enclosure at the connection ports and allow the subscriber cable to pass through the fitting to the interior of the fiber optic enclosure.

### SUMMARY

An aspect of the present disclosure relates to a cable pass-thru assembly having a fiber optic cable and a cable pass-thru fitting. The fiber optic cable includes an optical fiber and a strength member. The cable pass-thru fitting is adapted to receive at least a portion of the fiber optic cable. The cable pass-thru fitting includes a cable retention assembly having an outer sleeve and an inner sleeve. The outer sleeve includes a thru-bore. The inner sleeve is disposed in the thru-bore of the outer sleeve. The strength member is compressed between the inner sleeve and the outer sleeve.

Another aspect of the present disclosure relates to a cable pass-thru assembly. The cable pass-thru assembly has a fiber optic cable and a cable pass-thru fitting. The fiber optic cable includes an optical fiber and a strength member. The cable pass-thru fitting is adapted to receive at least a portion of the fiber optic cable. The cable pass-thru fitting includes a cable retention assembly having an outer sleeve, an inner sleeve, a retainer and a sealing assembly. The outer sleeve includes a first axial end and an oppositely disposed second axial end. The outer sleeve defines a thru-bore. The inner sleeve is disposed in the thru-bore of the outer sleeve. The strength member is compressed between the inner sleeve and the outer sleeve. The retainer has a first end section and an oppositely disposed second end section. The retainer defines an internal bore. The second axial end of the outer sleeve is disposed in the internal bore of the retainer at the first end section. A sealing assembly is sealingly engaged to the fiber optic cable. The sealing assembly includes a sealing member and an end fitting. The end fitting is engaged to the second end section of the retainer.

Another aspect of the present disclosure relates to a method for inserting a fiber optic cable in a drop cable pass-thru fitting. The method includes inserting a fiber optic cable through a thru-bore of an outer sleeve of a pass-thru fitting and through a bore of an inner sleeve of the pass-thru fitting. A portion of a strength member of the fiber optic cable is wrapped about a first axial end portion of the inner sleeve. The outer sleeve is advanced over the inner sleeve so that the portion of the strength member is compressed between the outer sleeve and the inner sleeve.

A variety of additional aspects will be set forth in the description that follows. These aspects can relate to individual features and to combinations of features. It is to be understood that both the foregoing general description and the following detailed description are exemplary and explanatory only and are not restrictive of the broad concepts upon which the embodiments disclosed herein are based.

### DRAWINGS

FIG. 1 is a perspective view of a drop cable pass-thru assembly having exemplary features of aspects in accordance with the principles of the present disclosure.

FIG. 2 is an alternate perspective view of the drop cable pass-thru assembly of FIG. 1.

FIG. 3 is a perspective view of a fiber optic cable suitable for use with the drop cable pass-thru assembly of FIG. 1.

FIG. 4 is an exploded perspective view of the drop cable pass-thru assembly of FIG. 1.

FIG. 5 is an alternate exploded perspective view of the drop cable pass-thru assembly of FIG. 1.

FIG. 6 is a cross-sectional view of a drop cable pass-thru fitting suitable for use with the drop cable pass-thru assembly of FIG. 1.

FIG. 7 is an exploded perspective view of an inner sleeve and an outer sleeve suitable for use with the drop cable pass-thru assembly of FIG. 1.

FIG. 8 is an alternate exploded perspective view of the inner sleeve and outer sleeve of FIG. 7.

FIG. 9 is a cross-sectional view of the inner sleeve and outer sleeve of FIG. 7.

FIG. 10 is a perspective view of a retainer suitable for use with the drop cable pass-thru assembly of FIG. 1.

FIG. 11 is an alternate perspective view of the retainer of FIG. 10.

FIG. 12 is a cross-sectional view of the retainer of FIG. 10.

FIG. 13 is an exploded perspective view of a sealing assembly suitable for use with the drop cable pass-thru assembly of FIG. 1.

FIG. 14 is an alternate exploded perspective view of the sealing assembly of FIG. 13.

FIG. 15 is a cross-sectional view of the retainer of FIG. 10 and the sealing assembly of FIG. 13.

FIGS. 16-18 are perspective views of an end fitting suitable for use with the drop cable pass-thru assembly of FIG. 1.

FIG. 19 is a first end view of the end fitting of FIGS. 16-18.

FIG. 20 is a cross-sectional view of the end fitting taken on line 20-20 of FIG. 19.

FIG. 21 is a second end view of the end fitting of FIGS. 16-18.

FIG. 22 is a plan view of a knock-out suitable for use with the end fitting of FIGS. 16-18.

FIGS. 23-24 are a perspective view of a port assembly.

FIG. 25 is an exploded perspective view of the port assembly of FIGS. 23-24.

FIG. 26 is a first end view of a port member suitable for use with the port assembly of FIGS. 23-24.

FIG. 27 is a cross-sectional view taken on line 27-27 of FIG. 26.

FIG. 28 is a perspective view of a fiber optic enclosure.

FIG. 29 is an enlarged fragmentary view of the fiber optic enclosure of FIG. 28.

### DETAILED DESCRIPTION

Reference will now be made in detail to the exemplary aspects of the present disclosure that are illustrated in the accompanying drawings. Wherever possible, the same reference numbers will be used throughout the drawings to refer to the same or like structure.

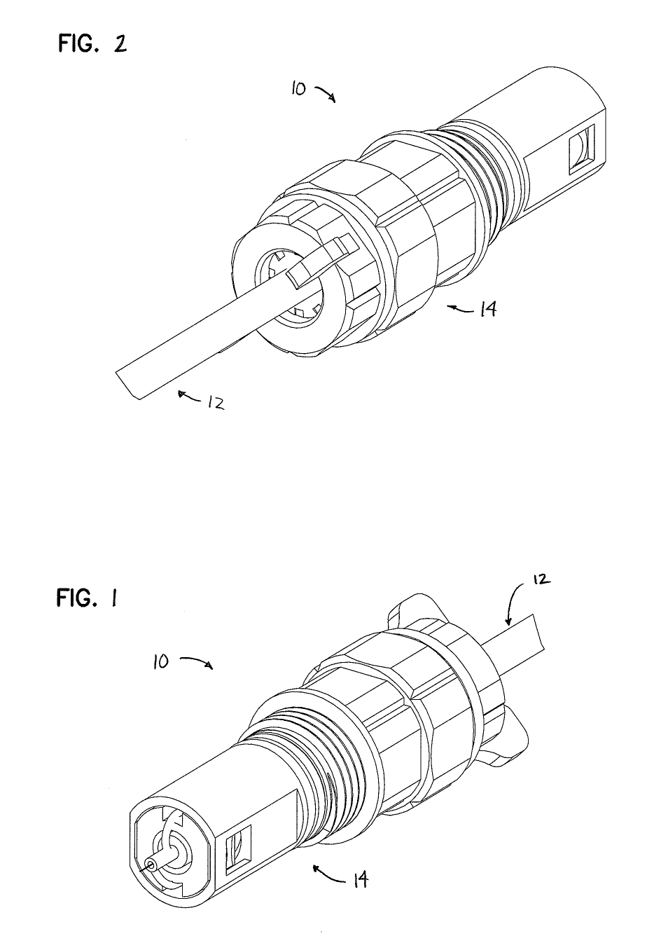

Referring now to FIGS. 1 and 2, a drop cable pass-thru assembly, generally designated 10, is shown. The drop cable pass-thru assembly 10 includes a fiber optic cable, generally designated 12, and a drop cable pass-thru fitting, generally designated 14.

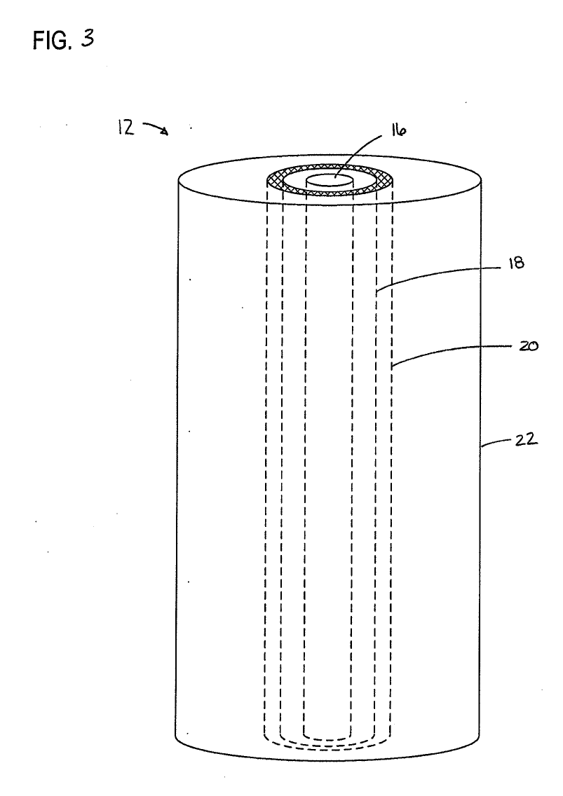

Referring now to FIG. 3, an exemplary fiber optic cable 12 that is suitable for use with the drop cable pass-thru fitting 14 is shown. The fiber optic cable 12 includes at least one optical fiber 16, a buffer layer 18 surrounding the optical fiber 16, a strength member 20, and an outer jacket 22.

The strength member 20 is adapted to inhibit axial tensile loading from being applied to the optical fiber 16. In one aspect of the present disclosure, the strength member 20 extends the length of the fiber optic cable 12 and is disposed in a generally longitudinal direction along the fiber optic cable 12 between the buffer layer 18 and the outer jacket 22. The strength layer 20 can include yarns, fibers, threads, tapes, films, epoxies, filaments or other structures. In one aspect of the present disclosure, the strength layer 20 includes a plurality of aramid yarns.

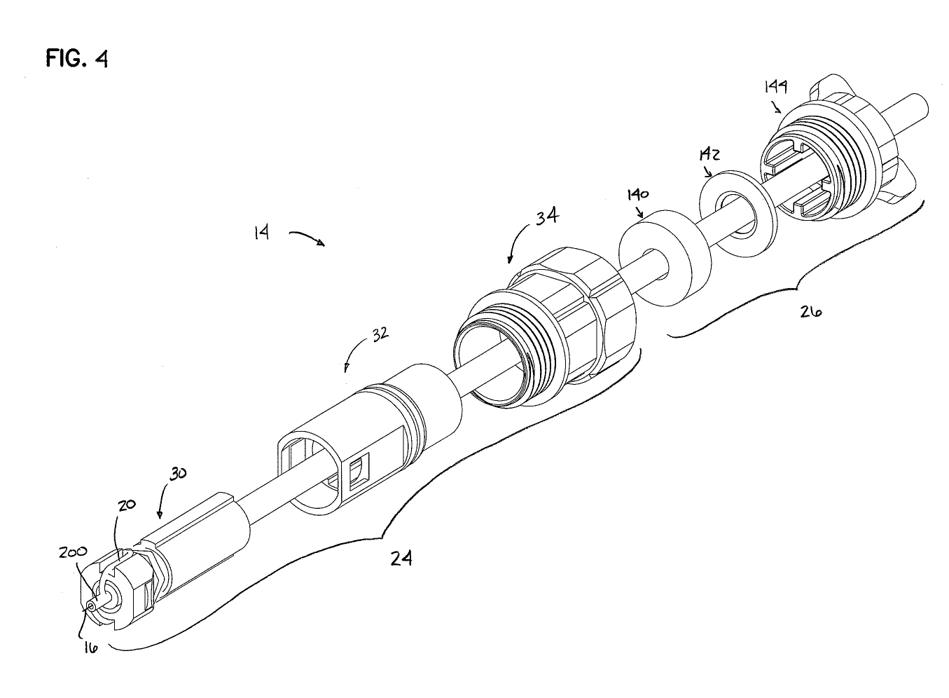

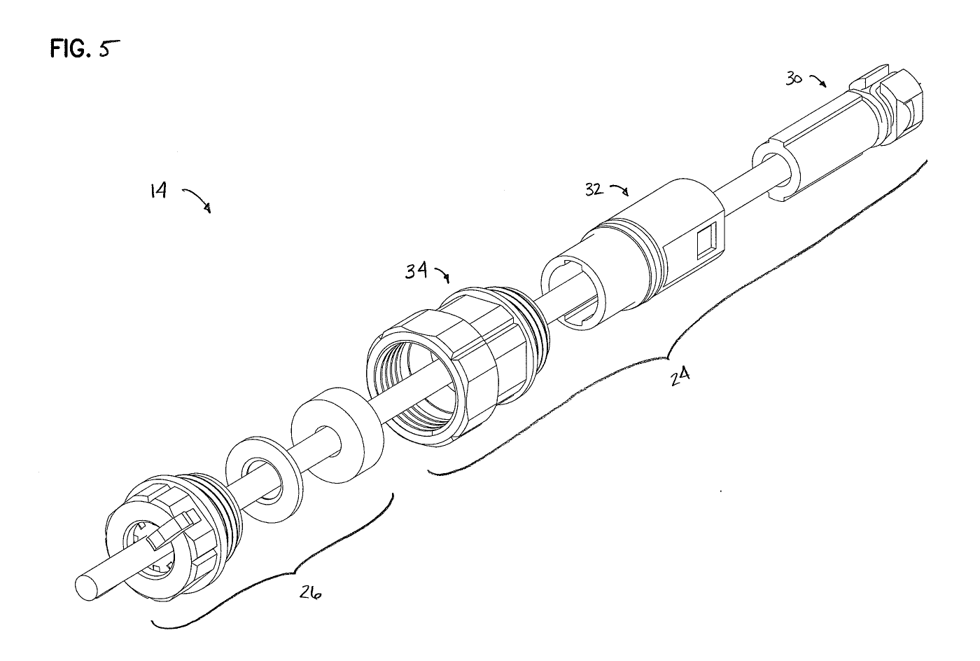

Referring now to FIGS. 4-6, the drop cable pass-thru fitting 14 is shown. The drop cable pass-thru fitting 14 is adapted for receipt in a wall of a fiber optic access terminal. The drop cable pass-thru fitting 14 defines a path through with the fiber optic cable 12 can enter an interior region of the fiber optic access terminal. The drop cable pass-thru fitting 14 includes a cable retention assembly, generally designated 24, and a sealing assembly, generally designated 26.

The cable retention assembly 24 is adapted to retain the fiber optic cable 12 in the drop cable pass-thru fitting 14. The cable retention assembly 24 includes an inner sleeve, generally designated 30, an outer sleeve, generally designated 32, and a retainer, generally designated 34.

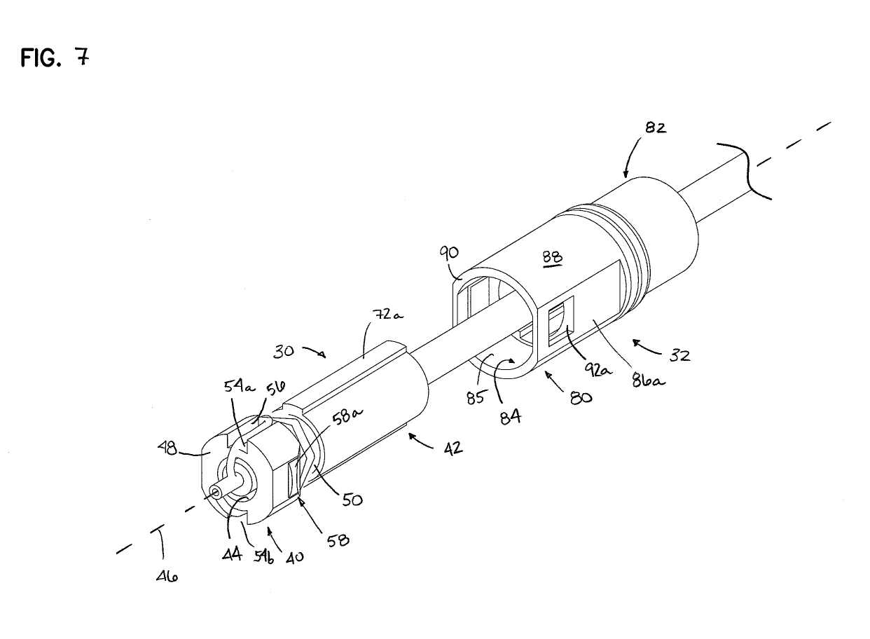

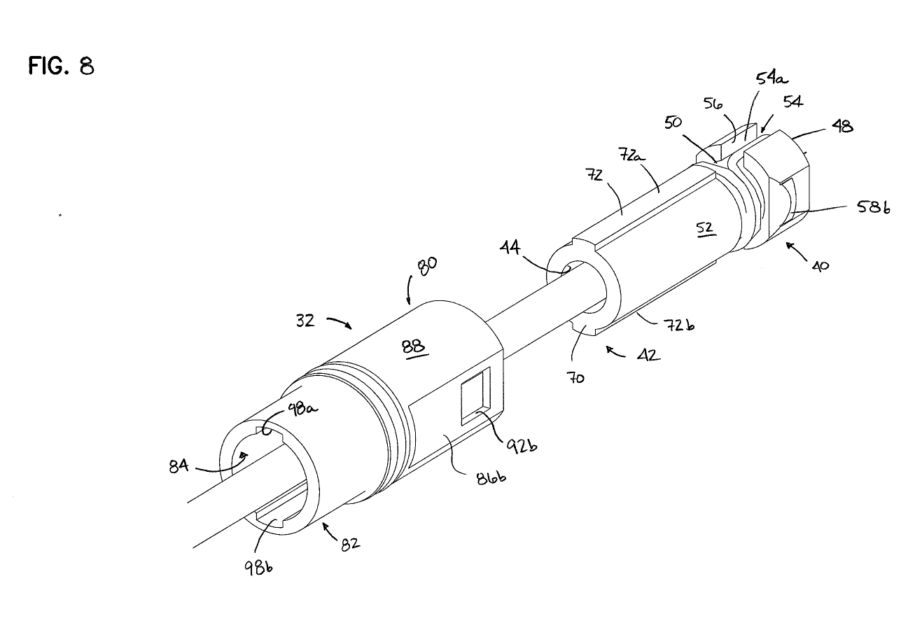

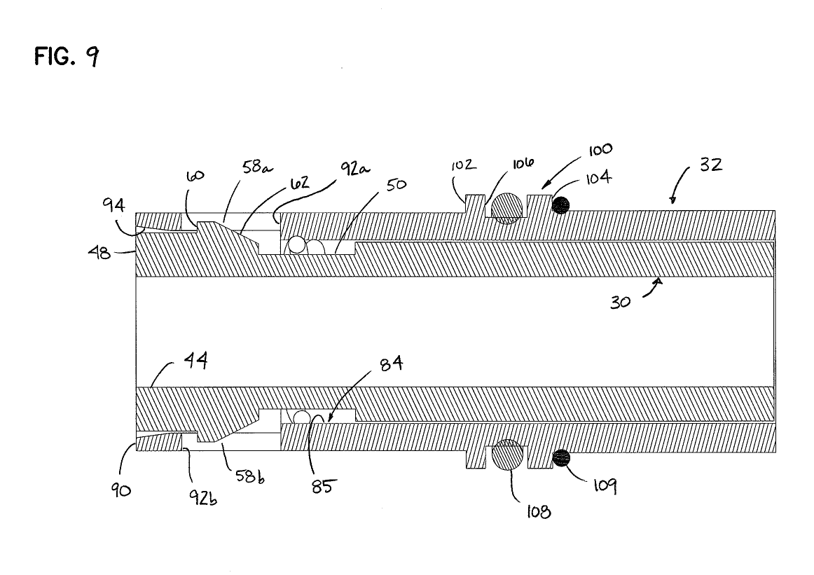

Referring now to FIGS. 7-9, the inner sleeve 30 and the outer sleeve 32 of the cable retention assembly 24 are shown. The inner sleeve 30 includes a first axial end portion 40 and an oppositely disposed second axial end portion 42 and defines a bore 44 that extends axially through the first and second axial end portions 40, 42 along a central longitudinal axis 46 of the drop cable pass-thru fitting 14.

The first axial end portion 40 includes a first axial end surface 48. In one aspect of the present disclosure, the first axial end surface 48 is generally perpendicular to the central longitudinal axis 46. The first axial end portion 40 defines a circumferential groove 50 disposed in an exterior surface 52 of the inner sleeve 30. The circumferential groove 50 is axially offset from the first axial end surface 48.

The first axial end portion 40 further defines a slot 54. In one aspect of the present disclosure, the first axial end portion 40 defines a first slot 54a and an oppositely disposed second slot 54b. The first and second slots 54a, 54b extend axially from the first axial end surface 48 to the circumferential groove 50. Each of the first and second slots 54a, 54b includes an opening 56 at the exterior surface 52 between the first axial end surface 48 and the circumferential groove 50.

The first axial end portion 40 includes a plurality of tabs 58. The plurality of tabs 58 is disposed between the first axial end surface 48 and the circumferential groove 50 and extends outwardly in a radial direction. In one aspect of the present disclosure, the first axial end portion 40 includes a first tab 58a and an oppositely disposed second tab 58b. In one aspect of the present disclosure, the first tab 58a is disposed on the exterior surface 52 between the first and second slots 54a, 54b. In one aspect of the present disclosure, the first tab 58a is disposed equidistantly from the first and second slots 54a, 54b.

Each of the first and second tabs 58a, 58b includes a lip 60 and an angled surface 62. The lip 60 is generally perpendicular to the central longitudinal axis 46. The angled surface 62 tapers inwardly in a first direction from the lip 60 toward the circumferential groove 50.

The second axial end portion 42 of the inner sleeve 30 is generally cylindrical in shape. The second axial end portion 42 includes a second axial end surface 70 that is generally perpendicular to the central longitudinal axis 46. In one aspect of the present disclosure, the second axial end surface 70 is generally parallel to the first axial end surface 48.

The second axial end portion 42 includes a projection 72. In one aspect of the present disclosure, the second axial end portion 42 includes a first projection 72a and an oppositely disposed second projection 72b. The first and second projections 72a, 72b extend outwardly in a radial direction from the exterior surface 52 of the inner sleeve 30 and in an axial direction from the circumferential groove 50 to the second axial end surface 70.

The outer sleeve 32 includes a first axial end 80 and a second axial end 82. The outer sleeve 32 defines a thru-bore 84 that extends through the first and second axial ends 80, 82. The thru-bore 84 includes an inner surface 85.

The first axial end 80 of the outer sleeve 32 is generally cylindrical in shape. In one aspect of the present disclosure, the first axial end 80 defines a first surface 86a on an outer surface 88 of the outer sleeve 32 and an oppositely disposed second surface 86b. In one aspect of the present disclosure, the first and second surfaces 86a, 86b are generally flat and generally parallel to the central longitudinal axis 46. The first and second surfaces 86a, 86b extend in an axial direction from a first end surface 90 of the outer sleeve 32.

The first surface 86a defines a first opening 92a while the second surface 86b defines a second opening 92b. Each of the first and second openings 92a, 92b extends from the outer surface 88 of the outer sleeve 32 through the thru-bore 84. The first and second openings 92 are adapted to receive the first and second tabs 58a, 58b of the inner sleeve 30, respectively.

The first axial end 80 of the outer sleeve 32 further includes a tapered opening 94 to the thru-bore 84. The tapered opening 94 extends from an end surface 96 of the first axial end 80 to first and second openings 92a, 92b. In one aspect of the present disclosure, the tapered opening tapers inwardly in a direction from the first axial end 80 to the second axial end 82.

The second axial end 82 of the outer sleeve 32 is generally cylindrical in shape. The second axial end 82 of the outer sleeve 32 defines a channel 98 disposed in the thru-bore 84. In one aspect of the present disclosure, the second axial end 82 defines a first channel 98a and an oppositely disposed second channel 98b. The first and second channels 98a, 98b are adapted to receive the first and second projections 72a, 72b of the inner sleeve 30.

The outer sleeve 32 further includes a collar 100 that is disposed between the first and second axial ends 80, 82. In one aspect of the present disclosure, an outer diameter of the collar 100 is greater than an outer diameter of the first and second axial ends 80, 82. The collar 100 includes a first surface 102 and an oppositely disposed second surface 104. In one aspect of the present disclosure, the first and second surfaces 102, 104 are generally perpendicular to the central longitudinal axis 46.

The collar 100 defines a groove 106. The groove 106 is adapted to receive a first sealing member 108. In one aspect of the present disclosure, the first sealing member 108 is an o-ring. A second sealing member 109 is disposed adjacent to the second surface 104 of the collar 100.

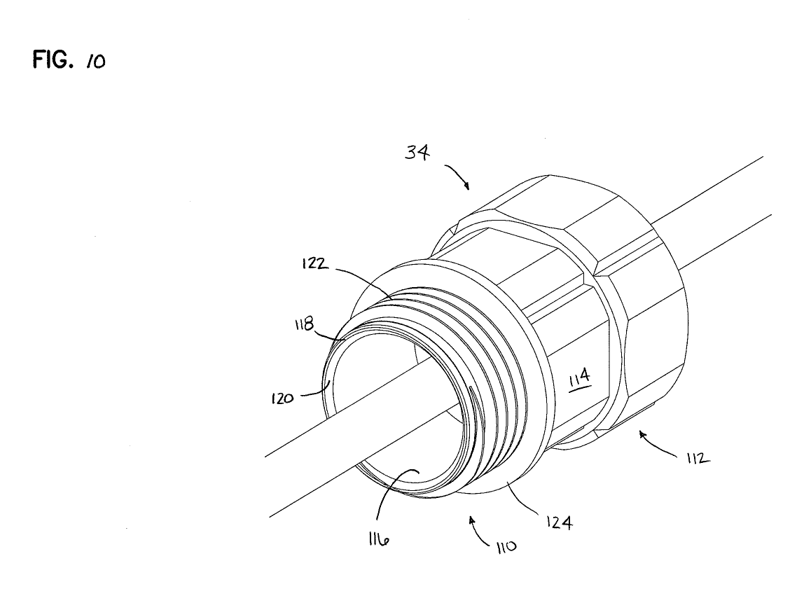

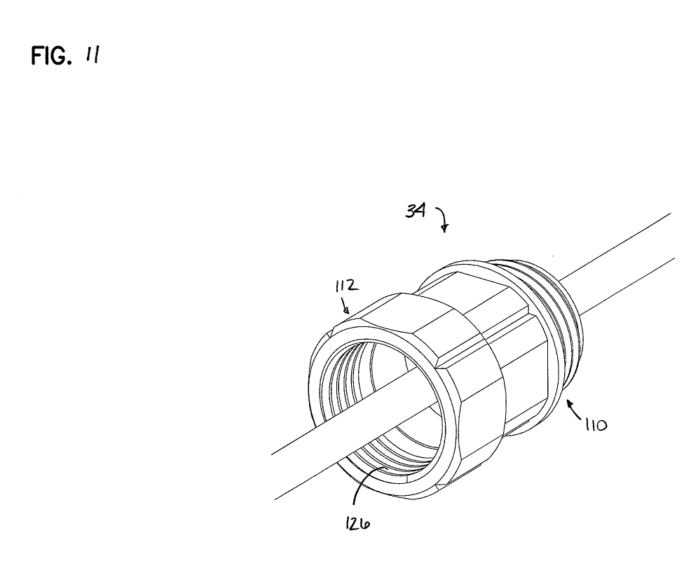

Referring now to FIGS. 10-12, the retainer 34 is shown. The retainer 34 includes a first end section 110, an oppositely disposed second end section 112 and an outer surface 114 that extends between the first and second end sections 110, 112. The retainer 34 defines an internal bore 116 that extends axially through the first and second end sections 110, 112.

The first end section 110 includes an axial end face 118. In one aspect of the present disclosure, the axial end face 118 includes a tapered portion 120. The tapered portion 120 is adapted to provide sealing engagement with the second sealing member 109 disposed adjacent to the second surface 104 of the collar 100 of the outer sleeve 32.

The first end section 110 further includes a plurality of external threads 122 disposed on the outer surface 114. The plurality of external threads 122 extends from the axial end face 118 to a flange 124. The flange 124 extends outwardly from the outer surface 114 of the retainer 34.

The internal bore 116 of the retainer 34 includes a plurality of internal threads 126. In one aspect of the present disclosure, the plurality of internal threads 126 is disposed in the internal bore 116 at the second end section 112.

The internal bore 116 further includes an annular rim 128. The annular rim 128 is disposed between the first and second end sections 110, 112 and is formed by an inner diameter of the interior bore 116 in the second end section 112 being larger than an inner diameter of the internal bore 116 in the first end section 110. The annular rim 128 includes a first end face 130 that faces toward the first end section 110 and a second end face 132 that faces toward the second end section 112. In one aspect of the present disclosure, the first and second end faces 130, 132 are generally perpendicular to the central longitudinal axis 46.

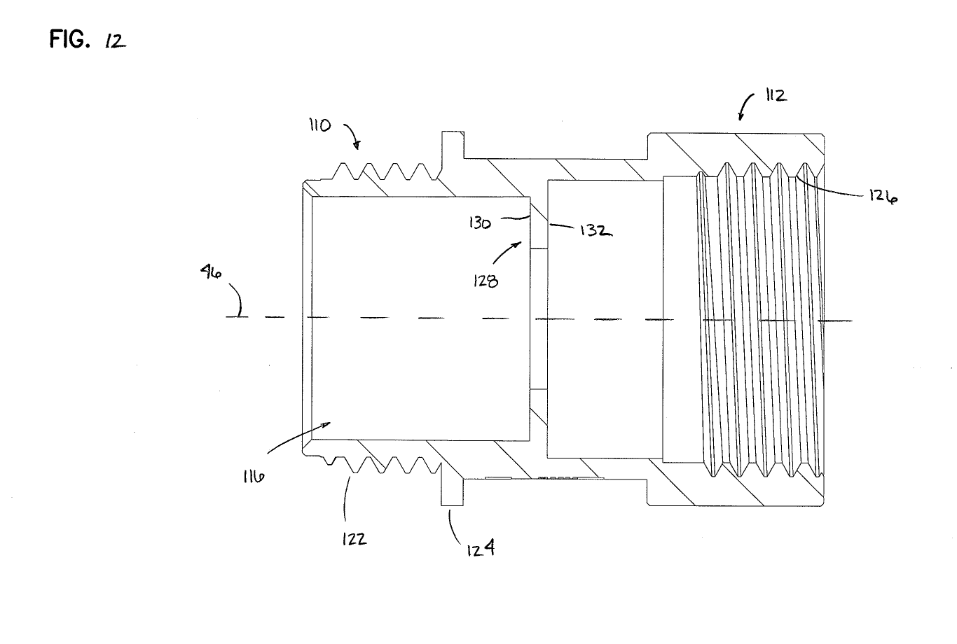

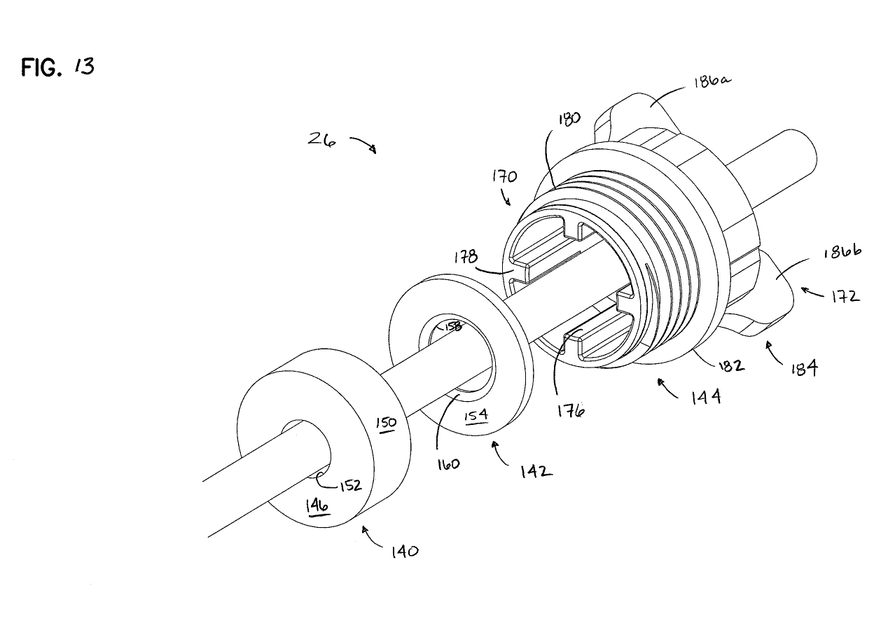

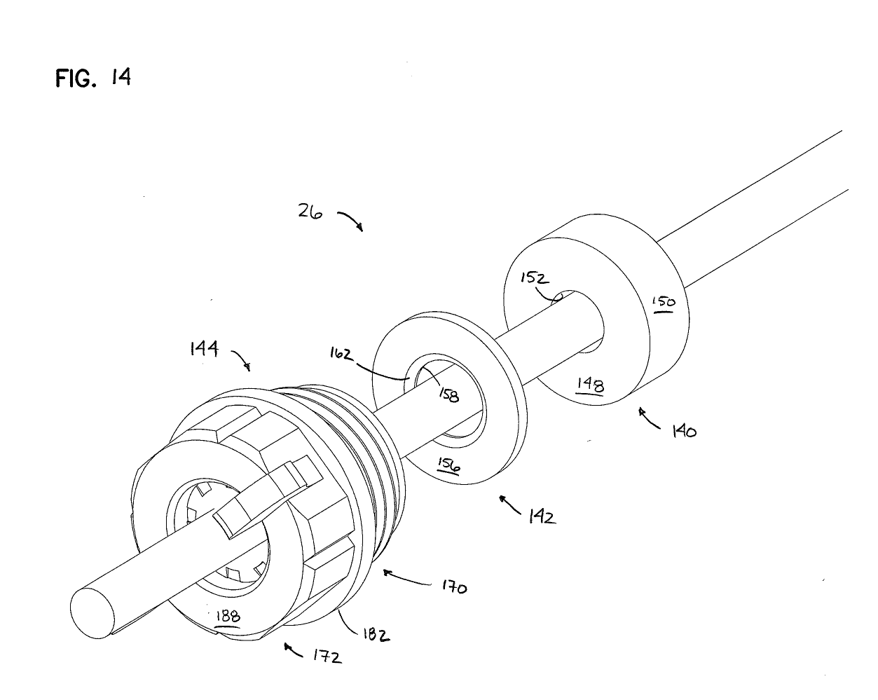

Referring now to FIGS. 13 and 14, the sealing assembly 26 is shown. The sealing assembly 26 includes a sealing member 140, a spacer 142 and an end fitting 144.

The sealing member 140 is adapted to sealingly engage the fiber optic cable 12. The sealing member 140 is a flexible and resilient sealing member that can be manufactured from convention sealing materials. The sealing member 140 includes a first end 146, an oppositely disposed second end 148 and an outer surface 150 that extends between the first and second ends 146, 148. The first and second ends 146, 148 are generally perpendicular to the central longitudinal axis 46. In one aspect of the present disclosure, the outer surface 150 is generally cylindrical in shape.

The sealing member 140 defines an inner bore 152. The inner bore 152 extends from the first end 146 through the second end 148. The inner bore 152 is adapted to receive the fiber optic cable 12.

The spacer 142 is adapted for disposition between the sealing member 140 and the end fitting 144. In one aspect of the present disclosure, the spacer 142 is made of a material have a greater rigidity than the material of the sealing member 140.

The spacer 142 includes a first side 154 and an oppositely disposed second side 156. The spacer 142 defines a thru-hole 158 that extends through the first and second sides 154, 156. The thru-hole 158 is adapted to receive the fiber optic cable 12. The spacer 142 further includes a first frusto-conical surface 160 surrounding the thru-hole 158 on the first side 154 and a second frusto-conical surface 162 surrounding the thru-hole 158 on the second side 156. The first and second frusto-conical surfaces 160, 162 are disposed on the spacer 142 such that the thickness of the spacer 142 between the first and second frusto-conical surfaces 160, 162 decreases as the distance from the central longitudinal axis 46 decreases.

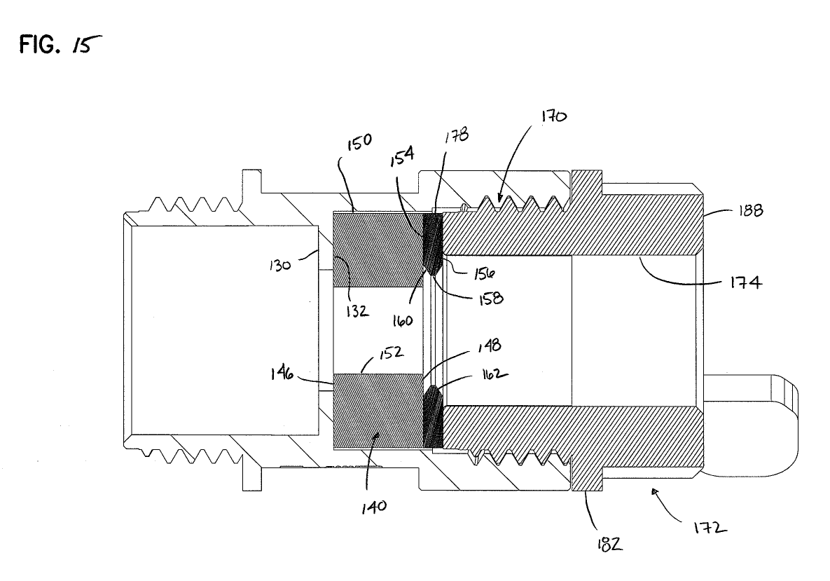

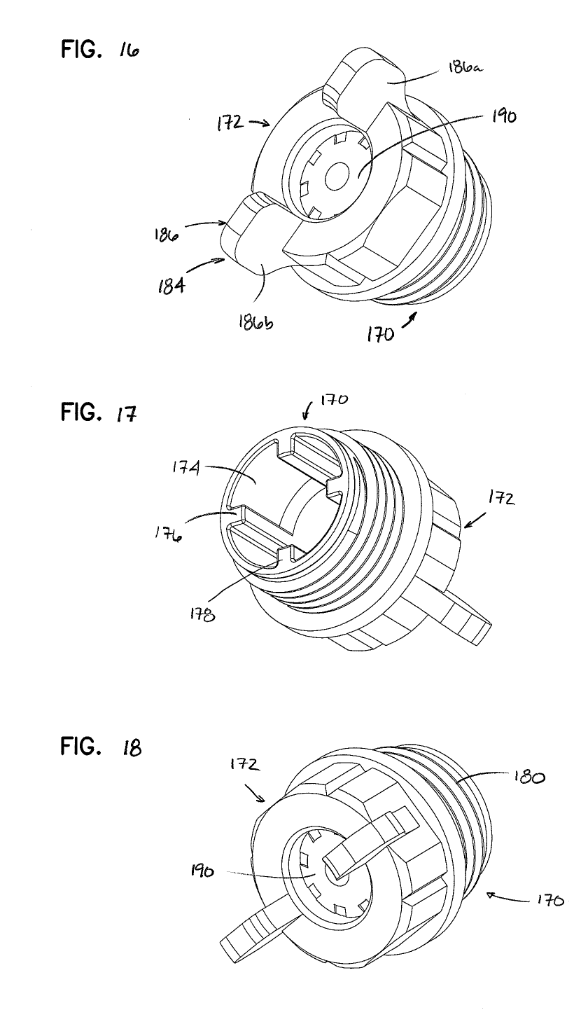

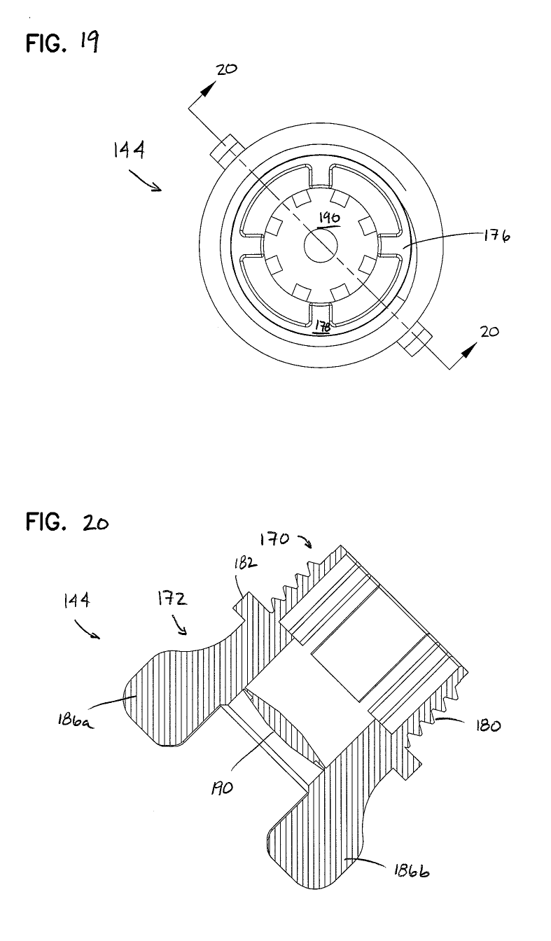

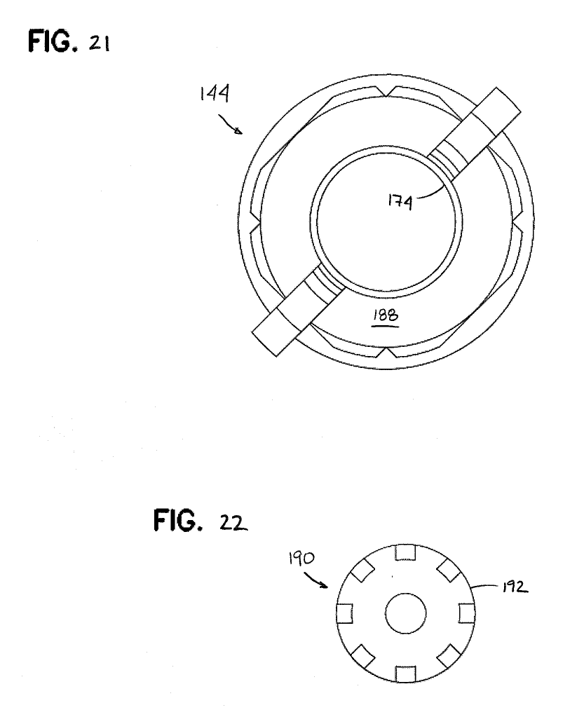

Referring now to FIGS. 13-22, the end fitting 144 is shown. The end fitting 144 includes a first end portion 170 and an oppositely disposed second end portion 172. The end fitting 144 defines a thru-passage 174 that extends through the first and second end portions 170, 172.

The first end portion 170 includes a plurality of protrusions 176 in the thru-passage 174 that projects inwardly in a radial direction. The plurality of protrusions 176 includes a first face 178 that is generally perpendicular to the central longitudinal axis 46. In one aspect of the present disclosure, the first face 178 of the plurality of protrusions is adapted for engagement with the second side 156 of the spacer 142.

The first end portion 170 further includes a retention member 180. In one aspect of the present disclosure the retention member 180 is a plurality of external threads. The plurality of external threads 180 extends from the first face 178 to a flange portion 182 that is disposed between the first and second end portions 170, 172. In one aspect of the present disclosure, the plurality of external threads 180 is adapted for engagement with the plurality of internal threads 126 in the internal bore 116 of the retainer 34.

The second end portion 172 includes a gripping portion 184. The gripping portion 184 provides a location at which an installer can grasp the end fitting 144 to install the end fitting 144 into a mating component (e.g., the retainer 34, etc.). In one aspect of the present disclosure, the gripping portion 184 includes a plurality of gripping tabs 186 that extend axially outward from a second face 188 of the second end portion 172. In one aspect of the present disclosure, the gripping portion 184 includes a first gripping tab 186a and an oppositely disposed second gripping tab 186b.

In one aspect of the present disclosure, the end fitting 144 includes a knock-out 190 disposed in the thru-passage 174 such that the knock-out 190 blocks the thru-passage 174. In one aspect of the present disclosure, the knock-out 190 enables the end fitting 144 to be used as a plug before the fiber optic cable 12 is installed.

In one aspect of the present disclosure, the knock-out 190 is biconvex in shape. In another aspect of the present disclosure, the knock-out 190 includes a center that is thicker than a perimeter of the knock-out 190.

A perimeter 192 of the knock-out 190 is attached to an inner diameter of the thru-passage 174. In one aspect of the present disclosure, the perimeter 192 is attached to the inner diameter of the thru-passage 174 at the second end portion 172. The knock-out 190 is adapted for selective removal from the thru-passage 174. When the fiber optic cable 12 is to be installed, the knock-out 190 is removed from the thru-passage 174. With the knock-out removed, the thru-passage 174 extends from the first end portion 170 to the second end portion 172.

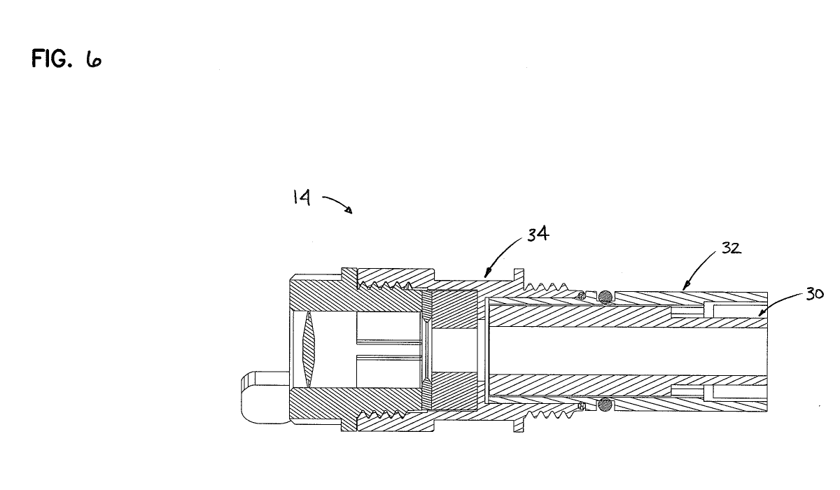

Referring now to FIGS. 4 and 6, the assembly of the drop cable pass-thru fitting 14 and the insertion of the fiber optic cable 12 through the drop cable pass-thru fitting 14 will be described. With the knock-out 190 removed from the thru-passage 174 of the end fitting 144, an end 200 of the fiber optic cable 12 is inserted through the thru-passage 174 of the end fitting 144 and through the thru-hole 158 of the spacer 142 and the inner bore 152 of the sealing member 140 in a cable insertion direction 202 (shown as an arrow in FIG. 4). The end 200 of the fiber optic cable 12 is then passed through the internal bore 116 of the retainer 34, the thru-bore 84 of the outer sleeve 32 and the bore 44 of the inner sleeve 30. At least the optical fiber 16 and the strength member 20 pass through the bore 44 of the inner sleeve 30.

The strength member 20 is routed from the bore 44 of the inner sleeve 30 across the first axial end surface 48 to the first slot 54a. The strength member 20 enters the first slot 54a through the opening 56 in the exterior surface 52 of the first axial end portion 40 of the inner sleeve 30. With the strength member 20 disposed through the first slot 54a, an end of the strength member 20 faces in a direction that is opposite the cable insertion direction 202. An end portion of the strength member 20 is then wrapped around the first axial end portion 40 in the circumferential groove 50. In one aspect of the present disclosure, the strength member 20 is wrapped around the first axial end portion 40 at least once. In another aspect of the present disclosure, the strength member 20 is wrapped around the first axial end portion 40 at least twice. In one aspect of the present disclosure, with the end portion of the strength member 20 is wrapped around the first axial end portion 40 in the circumferential groove 50, the end of the strength member 20 is routed through the opening 56 of the second slot 54b.

With the strength member 20 disposed in the circumferential groove 50 of the first axial end portion 40 of the inner sleeve 30, the outer sleeve 32 is advanced over the inner sleeve 30. As the outer sleeve 32 is oriented with respect to the inner sleeve 30 such that the first and second channels 98a, 98b of the outer sleeve 32 are aligned with the first and second projections 72a, 72b of the inner sleeve 30. The first axial end 80 of the outer sleeve 32 is then advanced over the second axial end portion 42 of the inner sleeve 30. As the outer sleeve 32 is advanced, the angled surfaces 62 of the first and second tabs 58a, 58b engage the tapered opening 94 of the thru-bore 84 of the outer sleeve 32. As the outer sleeve 32 is advanced, the tapered opening 94 flexes outwardly. The outer sleeve 32 is advanced until the first and second tabs 58a, 58b are received in the first and second openings 92a, 92b of the outer sleeve 32. The engagement of the first and second tabs 58a, 58b and the first and second openings 92a, 92b axially retains the inner sleeve 30 in the thru-bore 84 of the outer sleeve 32. The disposition of the first and second projections 72a, 72b of the inner sleeve 30 in the first and second channels 98a, 98b of the outer sleeve 32 rotationally retains the inner sleeve 30 in the thru-bore 84 of the outer sleeve 32.

With the outer sleeve 32 engaged to the inner sleeve 30, the strength member 20 of the fiber optic cable 12 is compressed between the inner surface 85 of the thru-bore 84 of the outer sleeve 32 and the circumferential groove 50 of the inner sleeve 30. In one aspect of the present disclosure, the strength member 20 is held between the inner surface 85 of the thru-bore 84 of the outer sleeve 32 and the circumferential groove 50 by friction at the interface between the strength member 20 and the inner surface 85 and the interface between the strength member 20 and the circumferential groove 50. In another aspect of the present disclosure, the strength member 20 is retained in the cable retention assembly 24 between a sidewall 204 of the circumferential groove 50 of the inner sleeve 30 and a shoulder 206 disposed in the first axial end 80 of the thru-bore 84 of the outer sleeve 32.

With the outer sleeve 32 engaged to the inner sleeve 30, the second axial end 82 of the outer sleeve 32 is inserted into the internal bore 116 of the first end section 110 of the retainer 34. In one aspect of the present disclosure, the retainer 34 is free to rotate about the outer sleeve 32 when the outer sleeve 32 is disposed in the internal bore 116 of the first end section 110.

The sealing member 140 is inserted into the internal bore 116 of the second end section 112 of the retainer 34. The sealing member 140 is inserted such that the first end 146 of the sealing member 140 abuts the second end face 132 of the annular rim 128 of the retainer 34. The spacer 142 is then inserted into the internal bore 116 of the second end section 112 of the retainer 34. The spacer 142 is inserted such that the first side 154 of the spacer 142 abuts the second end 148 of the sealing member 140.

The end fitting 144 is then inserted into the second end section 112 of the retainer 34. In one aspect of the present disclosure, the plurality of external threads 180 is engaged with the plurality of internal threads 126 in the internal bore 116 of the retainer 34. As the end fitting 144 is advanced into the internal bore 116 of the retainer 34, the first face 178 of the end fitting 144 abuts the second side 156 of the spacer 142 and compresses the sealing member 140 between the first side 154 of the spacer 142 and the second end face 132 of the annular rim 128 of the retainer 34. As the sealing member 140 is compressed, the inner bore 152 of the sealing member 140 compresses and seals around the fiber optic cable 12.

The fiber optic cable 12 is axially retained in the drop cable pass-thru fitting 14 by the engagement of the strength member 20 with the cable retention assembly 24. With the strength member 20 secured between the inner sleeve 30 and the outer sleeve 32, a pull-out force applied to the fiber optic cable 12 in a direction opposite the cable insertion direction 202 is transferred to the drop cable pass-thru fitting 14 through the engagement between the strength member 20 and the cable retention assembly 24. This force transfer prevents the pull-out force from acting directly on the optical fiber 16 of the fiber optic cable 12 and potentially damaging the optical fiber 16.

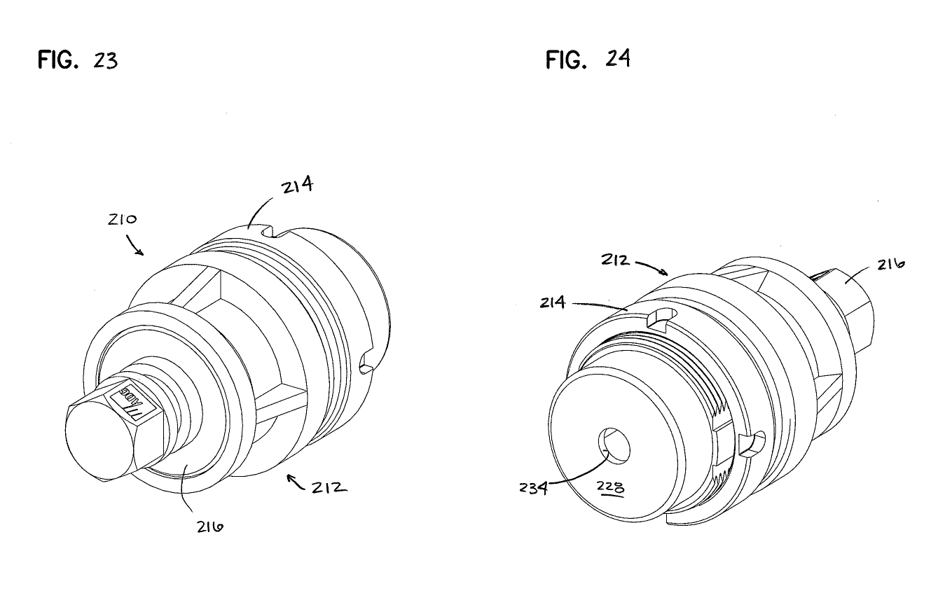

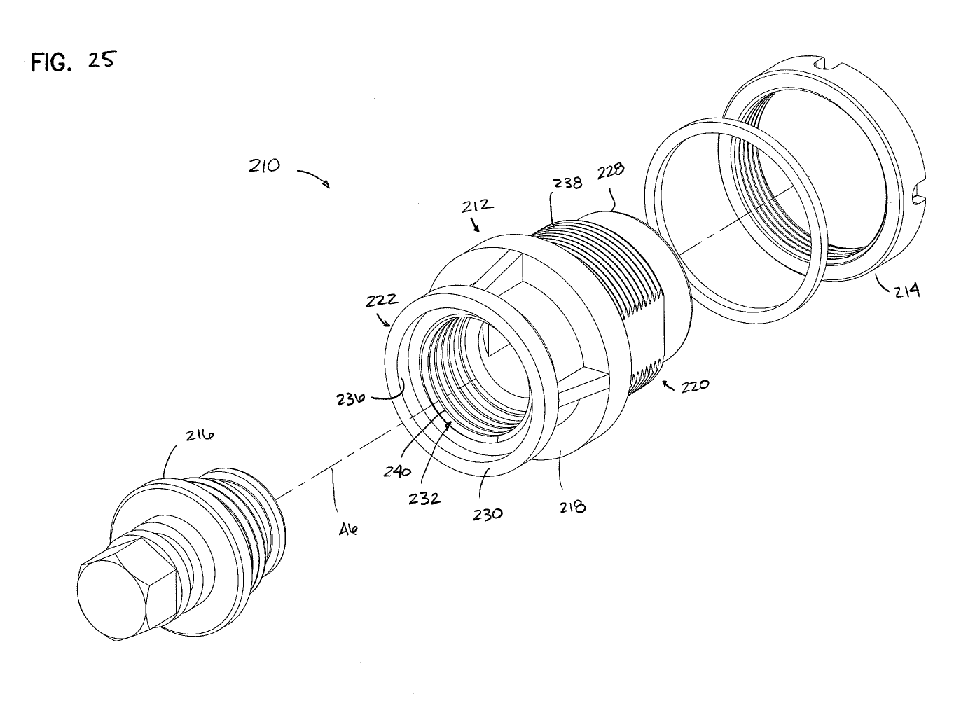

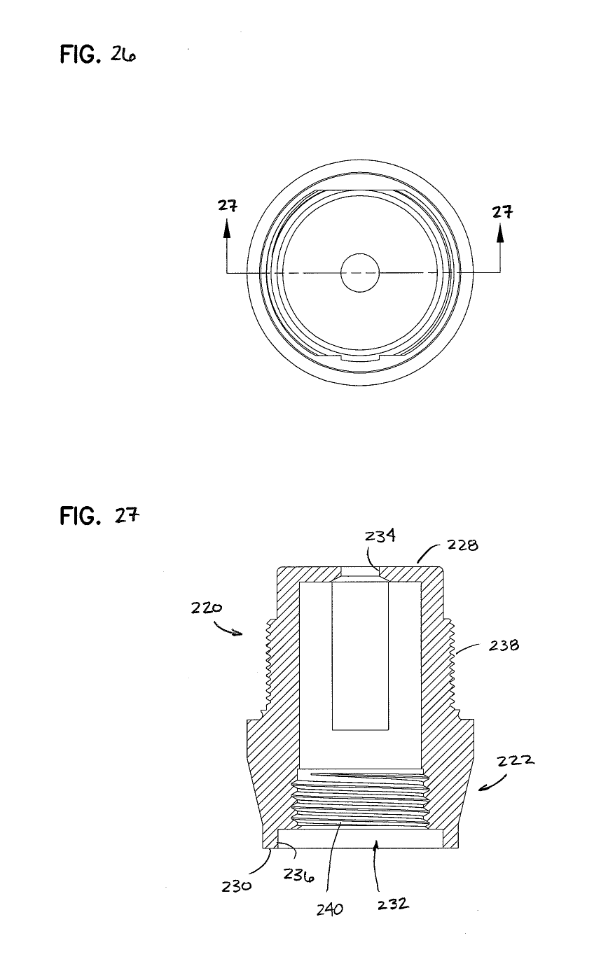

Referring now to FIGS. 23-27, a port assembly 210 is shown. The port assembly 210 includes a port member 212, a retention nut 214 and a plug 216.

The port member 212 and the retention nut 214 are adapted to engage a wall of a fiber optic enclosure and the drop cable pass-thru fitting assembly 10. The port member 212 includes a body 218.

The body 218 is generally cylindrical in shape and includes a first axial end region 220 and an oppositely disposed second axial end region 222. The first axial end region 220 includes a first end 228 that is generally perpendicular to the central longitudinal axis 46 while the second axial end region includes a second end 230 that is generally perpendicular to the central longitudinal axis 46.

The body 218 defines a passageway 232 that extends between the first and second axial end regions 220, 222. The passageway 232 includes a first opening 234 in the first axial end region 220 and a second opening 236 in the second axial end region 222. In one aspect of the present disclosure, the first opening 234 includes an inner diameter that is smaller than an inner diameter of the second opening 236.

The first axial end region 220 includes a plurality of external threads 238 that is adapted for engagement in an opening of the fiber optic enclosure. The second axial end region 222 includes a plurality of internal threads 240 disposed in the passageway 232. In one aspect of the present disclosure, the plurality of internal threads 240 is adapted for engagement with the drop cable pass-thru fitting 14.

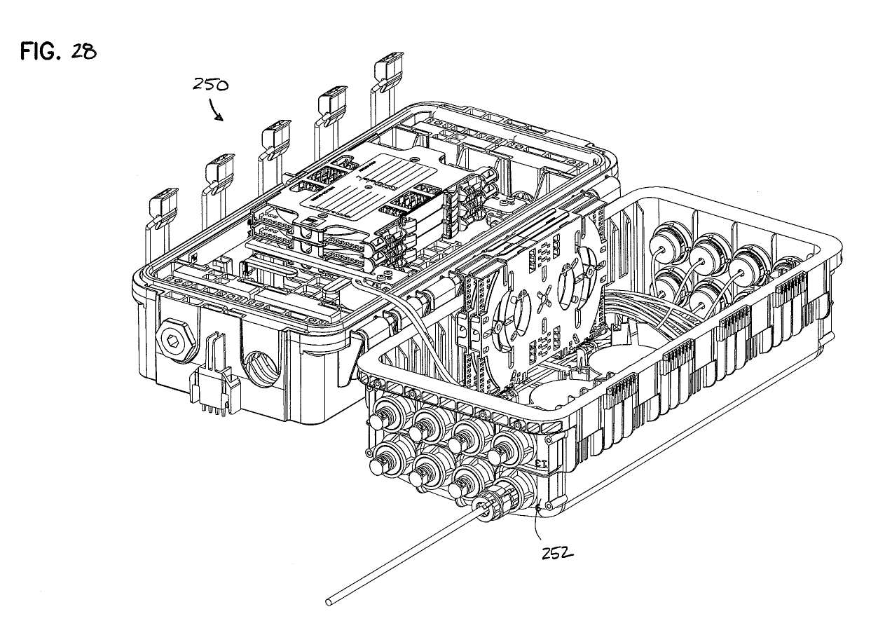

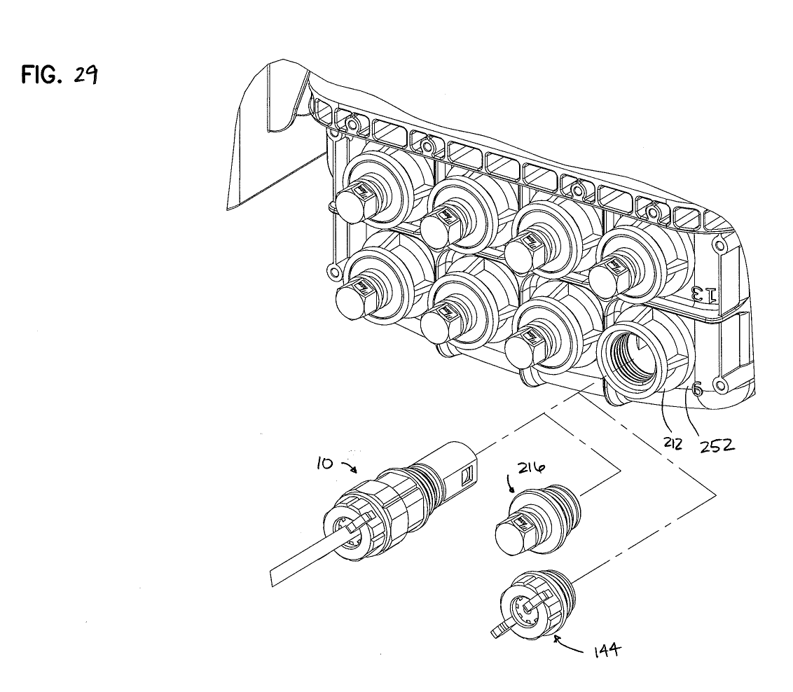

Referring now to FIGS. 28 and 29, a fiber optic enclosure 250 is shown. The fiber optic enclosure 250 includes a sidewall 252 having a plurality of openings (obstructed by the port member 212 in FIGS. 28 and 29). Each of the openings of the sidewall 252 is adapted to receive the port member 212. In one aspect of the present disclosure, the plurality of external threads 238 of the first axial end region 220 of the port member 212 is in threaded engagement with the opening in the sidewall 252.

In one aspect of the present disclosure, the plug 216 is engaged with the second axial end region 222 of the port member 212 when the drop cable pass-thru assembly 10 is not installed. In another aspect of the present disclosure, the end fitting 144 is engaged with the second axial end region 222 of the port member 212 when the drop cable pass-thru assembly 10 is not installed.

To install the drop cable pass-thru assembly 10, the plug 216 or the end fitting 144 is removed from the second axial end region 222 of the port member 212. The optical fiber 16 is inserted through the passageway 232 of the port member 212 and through the first opening 234.

The drop cable pass-thru fitting 14 is then inserted into the passageway 232. The plurality of external threads 122 on the outer surface 114 of the retainer 34 are engaged with the plurality of internal threads 240 in the passageway 232. In one aspect of the present disclosure, the retainer 34 is engaged with the port member 212 before the end fitting 144 is engaged to the retainer 34. This may reduce the risk of the fiber optic cable 12 rotating with the retainer 34.

In one aspect of the present disclosure, the portion of the strength member 20 that is routed across the first axial end surface 48 of the first axial end portion 40 of the inner sleeve 30 is compressed between the first axial end surface 48 of the inner sleeve 30 and the first end 228 of the port member 212. With the strength member 20 compressed between the first axial end surface 48 of the inner sleeve 30 and the first end 228 of the port member 212, friction at the interface between the strength member 20 and the first axial end surface 48 and the strength member 20 and the first end 228 further retains the fiber optic cable 12 in the drop cable pass-thru fitting 14.

Various modifications and alterations of this disclosure will become apparent to those skilled in the art without departing from the scope and spirit of this disclosure, and it should be understood that the scope of this disclosure is not to be unduly limited to the illustrative embodiments set forth herein.

What is claimed is:

1. A cable pass-thru assembly comprising:
a fiber optic cable having an optical fiber and a strength member;
a cable pass-thru fitting adapted to receive at least a portion of the fiber optic cable, the cable pass-thru fitting including:
a cable retention assembly having:
an outer sleeve defining a thru-bore; and
an inner sleeve disposed in the thru-bore of the outer sleeve, wherein the strength member of the fiber optic cable is compressed between the inner sleeve and the outer sleeve.

2. The cable pass-thru assembly of claim 1, wherein the inner sleeve defines a circumferential groove disposed on an exterior surface of the inner sleeve.

3. The cable pass-thru assembly of claim 2, wherein the inner sleeve includes a first axial end portion and an oppositely disposed second axial end portion, the circumferential groove being defined by the first axial end portion.

4. The cable pass-thru assembly of claim 3, wherein the inner sleeve defines a slot that extends from a first axial end surface of the first axial end portion to the circumferential groove.

5. The cable pass-thru assembly of claim 4, wherein the inner sleeve defines a plurality of slots.

6. The cable pass-thru assembly of claim 1, wherein the inner sleeve includes a first axial end portion and an oppositely disposed second axial end portion, the first axial end portion including a plurality of tabs.

7. The cable pass-thru assembly of claim 6, wherein the outer sleeve includes a first axial end and an oppositely disposed second axial end, the first axial end defining a plurality of openings adapted to receive the tabs of the inner sleeve.

8. The cable pass-thru assembly of claim 1, wherein the cable pass-thru fitting further includes a retainer defining an internal bore, the internal bore being adapted to receive the outer sleeve.

9. The cable pass-thru assembly of claim 1, wherein the cable pass-thru fitting includes a sealing assembly that is adapted to sealingly engage the fiber optic cable.

10. The cable pass-thru assembly of claim 9, wherein the sealing assembly includes a sealing member and an end fitting.

11. A cable pass-thru assembly comprising:
a fiber optic cable having an optical fiber and a strength member;
a cable pass-thru fitting adapted to receive at least a portion of the fiber optic cable, the cable pass-thru fitting including:
a cable retention assembly having:
an outer sleeve having a first axial end and an oppositely disposed second axial end, the outer sleeve defining a thru-bore;
an inner sleeve disposed in the thru-bore of the outer sleeve, wherein the strength member of the fiber optic cable is compressed between the inner sleeve and the outer sleeve;
a retainer having a first end section and an oppositely disposed second end section, the retainer defining an internal bore, the second axial end of the outer sleeve being disposed in the internal bore of the retainer at the first end section; and
a sealing assembly sealingly engaged to the fiber optic cable, the sealing assembly including a sealing member and an end fitting, wherein the end fitting is engaged to the second end section of the retainer.

12. The cable pass-thru assembly of claim 11, wherein the inner sleeve defines a circumferential groove disposed on an exterior surface of the inner sleeve.

13. The cable pass-thru assembly of claim 12, wherein the inner sleeve includes a first axial end portion and an oppositely disposed second axial end portion, the circumferential groove being defined by the first axial end portion.

14. The cable pass-thru assembly of claim 13, wherein the inner sleeve defines a slot that extends from a first axial end surface of the first axial end portion to the circumferential groove.

15. The cable pass-thru assembly of claim 14, wherein the inner sleeve defines a plurality of slots.

16. The cable pass-thru assembly of claim 11, wherein the inner sleeve includes a first axial end portion and an oppositely disposed second axial end portion, the first axial end portion including a plurality of tabs.

17. The cable pass-thru assembly of claim 16, wherein the outer sleeve includes a first axial end and an oppositely disposed second axial end, the first axial end defining a plurality of openings adapted to receive the tabs of the inner sleeve.

18. A method for inserting a fiber optic cable in a drop cable pass-thru fitting, the method comprising:
inserting a fiber optic cable through a thru-bore of an outer sleeve of a pass-thru fitting and through a bore of an inner sleeve of the pass-thru fitting;
wrapping a portion of a strength member about a first axial end portion of the inner sleeve;
advancing the outer sleeve over the inner sleeve so that the portion of the strength member is compressed between the outer sleeve and the inner sleeve.

19. The method of claim 18, wherein the portion of the strength member is disposed in a circumferential groove defined by the inner sleeve.

20. The method of claim 18, further comprising engaging a sealing member to the fiber optic cable.
